(19) United States
(12) Patent Application Publication
(10) Pub. No.: US 2024/0299955 A1
(43) Pub. Date: Sep. 12, 2024

(54) METHOD AND DEVICE FOR TEMPERATURE CONTROL OF CENTRIFUGE, CENTRIFUGE, AND STORAGE MEDIUM

(71) Applicants: QINGDAO HAIER BIOMEDICAL TECHNOLOGY CO., LTD., Qingdao (CN); QINGDAO HAIER BIOMEDICAL CO., LTD., Qingdao (CN)

(72) Inventors: Zepeng DUAN, Qingdao (CN); Huanwen JU, Qingdao (CN); Panfei WANG, Qingdao (CN); Huan CHEN, Qingdao (CN); Wei HU, Qingdao (CN); Dongchen YU, Qingdao (CN); Menglong YIN, Qingdao (CN)

(73) Assignees: QINGDAO HAIER BIOMEDICAL TECHNOLOGY CO., LTD., Qingdao (CN); QINGDAO HAIER BIOMEDICAL CO., LTD., Qingdao (CN)

(21) Appl. No.: 18/550,445

(22) PCT Filed: May 31, 2022
(86) PCT No.: PCT/CN2022/096160

§ 371 Date: Sep. 13, 2023

(30) Foreign Application Priority Data
Sep. 16, 2021 (CN) 202111089392.X

(51) Int. Cl. B04B 13/00; B04B 7/06; B04B 15/02

(52) U.S. Cl. CPC B04B 13/00; B04B 15/02; B04B 7/06

(57) ABSTRACT

Disclosed are a method and a device for temperature control of a centrifuge, a centrifuge and a storage medium. The method for temperature control of a centrifuge includes: acquiring a current temperature of the centrifugal chamber; in a case where a difference between the current temperature and a set temperature is less than or equal to a difference threshold value, according to the set temperature and a set rotational speed of the rotor, determining a target input parameter for temperature adjustment; and inputting the target input parameter, the current temperature and the set temperature into the PID controller.

### CROSS REFERENCE OF RELATED APPLICATION

This application is a U.S. National Stage under 35 U.S.C. 371 of the International Application PCT/CN2022/096160, filed on May 31, 2022, which claims priority to Chinese Patent Application No. CN202111089392.X, filed on Sep. 16, 2021, the contents of which are incorporated herein by reference in their entirety.

### TECHNICAL FIELD

The present disclosure relates to the technical field of centrifugal devices, for example, relates to a method and a device for temperature control of a centrifuge, a centrifuge and a storage medium.

### BACKGROUND

At present, the centrifugal chamber of the centrifuge is cooled by maximum power operation of the cooling system, and the cooling mode of rapidly approaching the target temperature is too rough to have cooling accuracy.

In the relative art, PID (Proportion, Integration, Differentiation) cooling control algorithm is adopted for refrigeration. During the centrifugal cooling process, the temperature is generally closed-loop controlled by PID, and a group of PID parameters are involved to control the whole temperature section, which has cooling accuracy to a certain extent.

In the process of the practice of the embodiment of the present disclosure, it is found that at least the following problems exist in the related art:

During actual cooling operation, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the ideal temperature control curve, thus affecting the accuracy of temperature adjustment of the centrifuge.

### SUMMARY

In order to have a basic understanding of some aspects of the disclosed embodiments, a brief summary is given below. The summary is not intended to be a general comment or to identify key/important constituent elements or to describe the scope of protection of these embodiments but rather to serve as a preface to the detailed description that follows.

The embodiment of the disclosure provides a method and a device for temperature control of a centrifuge, a centrifuge and a storage medium, so as to improve the accuracy of temperature adjustment of the centrifuge.

In some embodiments, the method comprises:
acquiring a current temperature of a centrifugal chamber;
in a case where a difference between the current temperature and a set temperature is less than or equal to a difference threshold value, according to the set temperature and a set rotational speed of a rotor, determining a target input parameter for temperature adjustment; and
inputting the target input parameter, the current temperature and the set temperature into a PID controller for temperature adjustment.

In some embodiments, the device comprises:
a processor and a memory having program instructions stored therein, and the processor being configured to execute the above-mentioned method for temperature control of the centrifuge when executing the program instructions.

In some embodiments, the centrifuge comprises:
the above-mentioned device for temperature control of the centrifuge.

In some embodiments, the storage medium stores program instructions that, at runtime, execute the above-mentioned method for temperature control of the centrifuge.

The method and the device for temperature control of the centrifuge, the centrifuge and the storage medium provided by the embodiment of the disclosure can achieve the following technical advantages:

With acquiring the current temperature of the centrifugal chamber; in a case where the difference between the current temperature and the set temperature is less than or equal to the difference threshold value, according to the set temperature and the set rotational speed of the rotor, determining the target input parameter for temperature adjustment; and inputting into the PID controller for temperature adjustment, it avoids the influence of heat generated by friction between the high-speed rotating rotor and the air during the centrifugal cooling process and improves the accuracy of temperature adjustment of the centrifuge.

The above general description and the description below are exemplary and explanatory only and are not intended to limit the present disclosure.

### BRIEF DESCRIPTION OF THE DRAWINGS

One or more embodiments are illustrated by means of the corresponding drawings, which do not constitute a limitation of the embodiments, elements having the same reference numeral numerals in the drawings are shown as like elements, the drawings do not constitute a limitation of proportion, and wherein:

FIG. 1 is a flow chart of the method for temperature control of the centrifuge provided by embodiments of the present disclosure.

FIG. 2 is a flow chart of another method for temperature control of the centrifuge provided by embodiments of the present disclosure.

FIG. 3 is a flow chart of another method for temperature control of the centrifuge provided by embodiments of the present disclosure.

FIG. 4 is a flow chart of another method for temperature control of the centrifuge provided by embodiments of the present disclosure.

FIG. 5 is a flow chart of another method for temperature control of the centrifuge provided by embodiments of the present disclosure.

FIG. 6 is a schematic diagram of the device for temperature control of the centrifuge provided by embodiments of the present disclosure.

### DETAILED DESCRIPTION OF THE EMBODIMENTS

In order to enable a more detailed understanding of the features and technical content of the embodiments of the present disclosure, the implementation of the embodiments of the present disclosure will be described in detail below in conjunction with the accompanying drawings, which are for illustration only and are not intended to limit the embodiments of the present disclosure. In the following technical description for convenience of explanation, a number of details are provided to provide a full understanding of the disclosed embodiments. However, one or more embodiments may still be practiced without these details. In other instances, well-known structures and devices may simplify the presentation in order to simplify the drawings.

The terms “first”, “second” and the like in the specification and claims of embodiments of the present disclosure and the above drawings are used to distinguish similar objects and are not necessarily used to describe a particular order or priority. It should be understood that the data used in this way can be interchanged where appropriate for the embodiments of the present disclosure described herein. Furthermore, the terms “comprise” and “have” and any variations thereof are intended to cover non-exclusive inclusion.

Unless otherwise stated, the term “a plurality of” means two or more.

In the embodiment of the present disclosure, the character “/” indicates that the front and back objects are an “or” relationship. For example, A/B stands for A or B.

The term “and/or” is an association relationship that describes objects, indicating that there can be three relationships. For example, A and/or B represent three relationships: A or B, or A and B.

The term “corresponding” can refer to an association or binding relationship, and the correspondence between A and B means that there is an association or binding relationship between A and B.

At present, the centrifuge comprises a housing, a centrifugal chamber, a rotor, a refrigeration device and a PID controller. The centrifugal chamber is disposed in the housing. The rotor is disposed in the centrifugal chamber. The refrigeration device comprises a compressor, a condenser, an expansion valve and an evaporator for adjusting the temperature of the centrifugal chamber. The PID controller can control the refrigeration device to adjust the temperature of the centrifugal chamber.

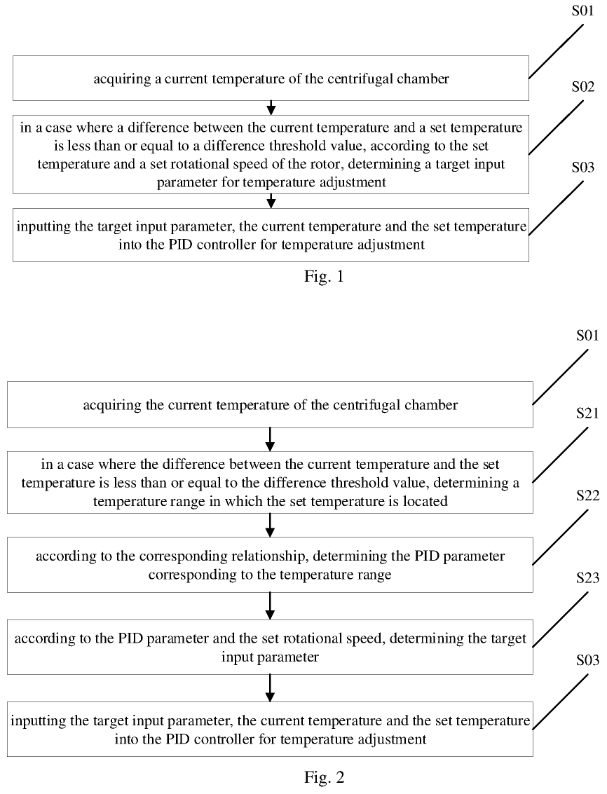

Based on the above structure, with reference to FIG. 1, the embodiment of the present disclosure provides a method for temperature control of the centrifuge, comprising:
S01, acquiring a current temperature of the centrifugal chamber;
S02, in a case where a difference between the current temperature and a set temperature is less than or equal to a difference threshold value, according to the set temperature and a set rotational speed of the rotor, determining a target input parameter for temperature adjustment; and
S03, inputting the target input parameter, the current temperature and the set temperature into the PID controller for temperature adjustment.

With the method for temperature control of the centrifuge provided by the embodiment of the present disclosure, the centrifuge can acquire the current temperature of the centrifugal chamber, and in a case where the difference between the current temperature and the set temperature is less than or equal to the difference threshold value, such as the difference between the current temperature and the set temperature is too small, the centrifuge employs the PID controller to accurately control the temperature adjustment on the centrifugal chamber. During the actual cooling process, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the ideal temperature control curve. Therefore, the centrifuge determines the target input parameter according to the set temperature and the set rotational speed of the rotor, and the centrifuge inputs the target input parameter, the current temperature and the set temperature into the PID controller for temperature adjustment. The embodiment incorporates the rotational speed of the rotor into the control algorithm, inputs the target input parameter into the PID controller for temperature adjustment, avoids the influence of heat generated by friction between the high-speed rotating rotor and the air during the centrifugal cooling process, and improves the accuracy of temperature adjustment of the centrifuge.

With reference to FIG. 2, the embodiment of the present disclosure provides a method for temperature control of the centrifuge comprising:
S01, acquiring the current temperature of the centrifugal chamber;
S21, in a case where the difference between the current temperature and the set temperature is less than or equal to the difference threshold value, determining a temperature range in which the set temperature is located;
S22, according to the corresponding relationship, determining the PID parameter corresponding to the temperature range;
S23, according to the PID parameter and the set rotational speed, determining the target input parameter; and
S03, inputting the target input parameter, the current temperature and the set temperature into the PID controller for temperature adjustment.

The PID parameter comprises a proportional parameter, an integral parameter and a differential parameter.

In this way, the centrifuge determines the temperature range in which the set temperature is located and determines the PID parameter corresponding to the temperature range according to the corresponding relationship. According to the temperature range in which the set temperature is located, the corresponding PID parameter can be determined, and the accurate adjustment from the current temperature to the set temperature can be realized. During the actual cooling process, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the ideal temperature control curve. Thus, according to the PID parameter and the set rotational speed, the centrifuge determines the target input parameter. The PID parameter comprises a proportional parameter, an integral parameter and a differential parameter. That is to say, the proportional term, integral term and differential term in the PID control algorithm are considered to affect the temperature adjustment process of the refrigeration device controlled by the PID controller. This proposal not only considers the influence of the temperature range in which the set temperature is located on temperature adjustment, but also considers the influence of the rotational speed of the rotor on temperature adjustment, and also considers the influence of proportional term, integral term and differential term in PID control algorithm on temperature adjustment, which greatly improves the accuracy of temperature adjustment of the centrifuge.

Optionally, the step of, according to the PID parameter and the set rotational speed, determining the target input parameter comprises: according to the set rotational speed, determining correction coefficient; and according to the correction coefficient, the proportional parameter and the integral parameter, determining the target input parameter.

In this way, the centrifuge determines the correction coefficient according to the set rotational speed, and determines the target input parameter of the PID controller by the correction coefficient, the proportional parameter and the integral parameter. In this proposal, the rotational speed of the rotor is included in the control algorithm, and the influence of proportional term, integral term and differential term in the PID control algorithm on the temperature adjustment process of the PID controller controlling refrigeration device is considered. The influence of heat generated by friction between the high-speed rotating rotor and air in the centrifugal refrigeration process is avoided, and the accuracy of temperature adjustment of the centrifuge is improved.

Optionally, the step of, according to the set rotational speed, determining the correction coefficient comprises: calculating K=(S/Smax)²; where K is the correction coefficient, Smax is the maximum speed of the rotor, and S is the set rotational speed.

In this way, calculating K=(S/Smax)², and the greater the set rotational speed S, the greater the correction coefficient K, which fully considers the influence of heat generated by friction between the high-speed rotating rotor and the air on the PID controller, and improves the accuracy of temperature adjustment of the centrifuge.

Optionally, the step of, according to the correction coefficient, the proportional parameter, and the integral parameter, determining the target input parameter comprises: calculating P=K×P0, I=K×I0; where the target input parameter comprises a proportional input parameter and an integral input parameter, P is proportional input parameter, I is integral input parameter, K is correction coefficient, P0 is the proportional parameter and I0 is the integral parameter.

In this way, calculating P=K×P0 and I=K×I0 to obtain the target input parameter. The influence of the rotational speed of the rotor on centrifuge cooling is fully considered. For example, in a case where the set rotational speed is equal to 15000 rpm, the K value is 1, that is, the PID parameter of the actual test condition (15000 rpm) is employed; in a case where the set rotational speed is less than 15000 rpm, the K value is less than 1, and the smaller the set rotational speed, the smaller the K value. Compared with low speed, high speed has a greater calorific value, which has a great influence on cooling operation, and P value and I value are also larger. After the centrifuge enters adjustment of the PID controller, the first half of temperature adjustment is adjusted by P value, so that the compressor can quickly refrigerate at high speed, quickly offset the influence of heat dissipation, and quickly approach the set temperature. The second half is adjusted by I value, and the output rotational speed of the compressor can also increase quickly, continuing to offset the influence of heat dissipation. Then, as time goes, it gradually reaches the set temperature.

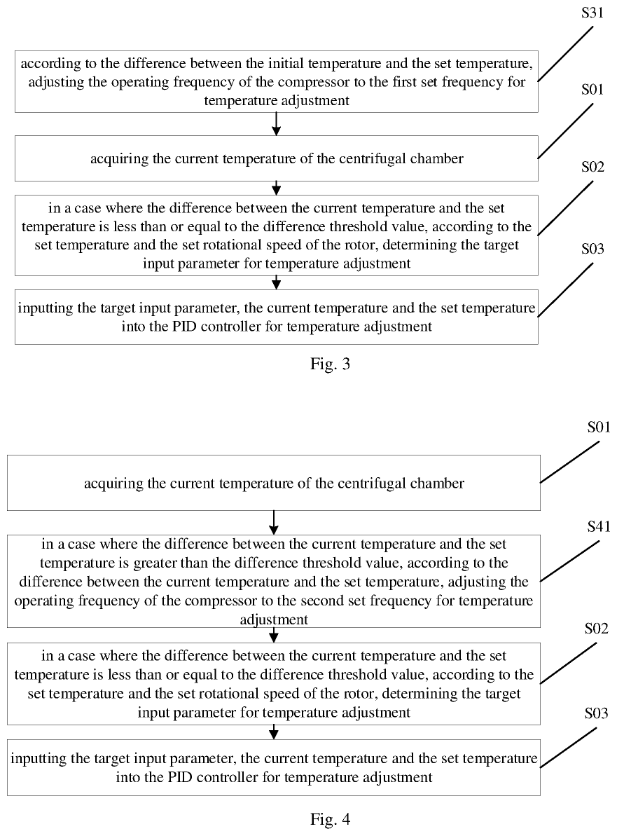

With reference to FIG. 3, the embodiment of the present disclosure provides a method for temperature control of the centrifuge comprising:
S31, according to the difference between the initial temperature and the set temperature, adjusting the operating frequency of the compressor to the first set frequency for temperature adjustment;
S01, acquiring the current temperature of the centrifugal chamber;
S02, in a case where the difference between the current temperature and the set temperature is less than or equal to the difference threshold value, according to the set temperature and the set rotational speed of the rotor, determining the target input parameter for temperature adjustment; and
S03, inputting the target input parameter, the current temperature and the set temperature into the PID controller for temperature adjustment.

With the method for temperature control of the centrifuge provided by the embodiment of the present disclosure, the centrifuge can acquire the current temperature of the centrifugal chamber, and in a case where the difference between the current temperature and the set temperature is less than or equal to the difference threshold value, such as the difference between the current temperature and the set temperature is too small, the centrifuge employs the PID controller to accurately control the temperature adjustment on the centrifugal chamber. During the actual cooling process, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the ideal temperature control curve. Therefore, the centrifuge determines the target input parameter according to the set temperature and the set rotational speed of the rotor, and the centrifuge inputs the target input parameter, the current temperature and the set temperature into the PID controller for temperature adjustment. The embodiment incorporates the rotational speed of the rotor into the control algorithm, inputs the target input parameter into the PID controller for temperature adjustment, avoids the influence of heat generated by friction between the high-speed rotating rotor and the air during the centrifugal cooling process, and improves the accuracy of temperature adjustment of the centrifuge. Further, before acquiring the current temperature of the centrifugal chamber, according to the difference between the initial temperature and the set temperature, the centrifuge adjusts the operating frequency of the compressor to the first set frequency for temperature adjustment. It can make the temperature of the centrifugal chamber rapidly approaching the set temperature, and then accurately adjust the temperature by the PID controller, which improves the efficiency of temperature adjustment of the centrifuge.

Optionally, the step of, according to the difference between the initial temperature and the set temperature, adjusting the operating frequency of the compressor to the first set frequency for temperature adjustment comprises: according to the preset first corresponding relationship, determining the first set frequency of the compressor corresponding to the difference between the initial temperature and the set temperature; and adjusting the operating frequency of the compressor to the first set frequency.

In this way, before acquiring the current temperature of the centrifugal chamber, according to the difference between the initial temperature and the set temperature, adjusting the operating frequency of the compressor to the first set frequency corresponding to the difference between the initial temperature and the set temperature for temperature adjustment. It can make the temperature of the centrifugal chamber rapidly approaching the set temperature, and then accurately adjust the temperature by PID controller, which improves the efficiency of temperature adjustment of centrifuge.

With reference to FIG. 4, the embodiment of the present disclosure provides a method for temperature control of the centrifuge comprising:
S01, acquiring the current temperature of the centrifugal chamber;
S41, in a case where the difference between the current temperature and the set temperature is greater than the difference threshold value, according to the difference between the current temperature and the set temperature, adjusting the operating frequency of the compressor to the second set frequency for temperature adjustment;
S02, in a case where the difference between the current temperature and the set temperature is less than or equal to the difference threshold value, according to the set temperature and the set rotational speed of the rotor, determining the target input parameter for temperature adjustment; and
S03, inputting the target input parameter, the current temperature and the set temperature into the PID controller for temperature adjustment.

With the method for temperature control of the centrifuge provided by the embodiment of the present disclosure, the centrifuge can acquire the current temperature of the centrifugal chamber, and in a case where the difference between the current temperature and the set temperature is less than or equal to the difference threshold value, such as the difference between the current temperature and the set temperature is too small, the centrifuge employs the PID controller to accurately control the temperature adjustment on the centrifugal chamber. During the actual cooling process, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the idcal temperature control curve. Therefore, the centrifuge determines the target input parameter according to the set temperature and the set rotational speed of the rotor, and the centrifuge inputs the target input parameter, the current temperature and the set temperature into the PID controller for temperature adjustment. The embodiment incorporates the rotational speed of the rotor into the control algorithm, inputs the target input parameter into the PID controller for temperature adjustment, avoids the influence of heat generated by friction between the high-speed rotating rotor and the air during the centrifugal cooling process, and improves the accuracy of temperature adjustment of the centrifuge. Further, after acquiring the current temperature of the centrifugal chamber, in a case where the difference between the current temperature and the set temperature is greater than the difference threshold value, according to the difference between the current temperature and the set temperature, the centrifuge adjusts the operating frequency of the compressor to the second set frequency for temperature adjustment. It can make the temperature of the centrifugal chamber rapidly approaching the set temperature, and then accurately adjust the temperature by PID controller, which improves the efficiency of temperature adjustment of the centrifuge.

Optionally, the step of, according to the difference between the current temperature and the set temperature, adjusting the operating frequency of the compressor to the second set frequency for temperature adjustment comprises: according to the preset second corresponding relationship, determining the second set frequency of the compressor corresponding to the difference between the current temperature and the set temperature; and adjusting the operating frequency of the compressor to the second set frequency.

In this way, after acquiring the current temperature of the centrifugal chamber, according to the difference between the current temperature and the set temperature, the centrifuge adjusts the operating frequency of the compressor to the second set frequency corresponding to the difference between the current temperature and the set temperature for temperature adjustment. It can make the temperature of the centrifugal chamber rapidly approaching the set temperature, and then accurately adjust the temperature by PID controller, which improves the efficiency of temperature adjustment of the centrifuge.

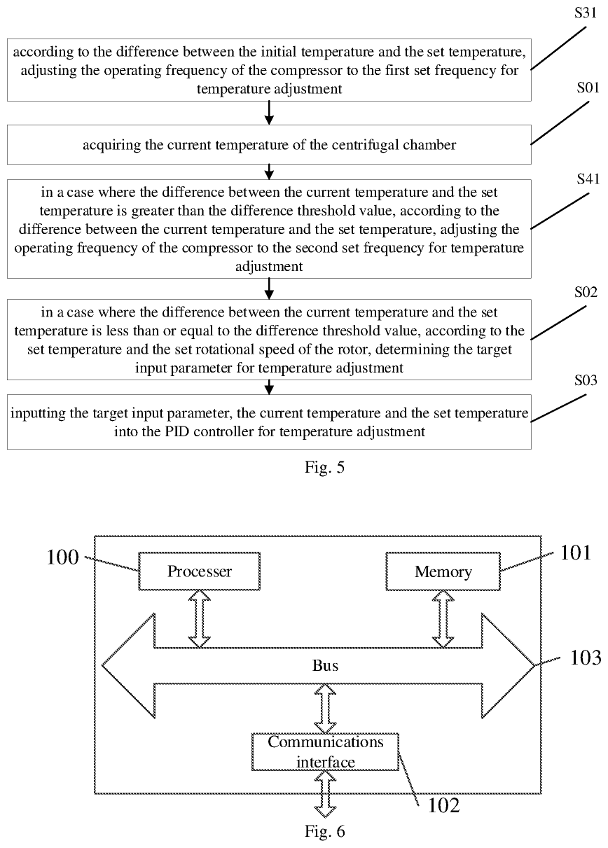

With reference to FIG. 5, the embodiment of the present disclosure provides a method for temperature control of the centrifuge comprising:
S31, according to the difference between the initial temperature and the set temperature, adjusting the operating frequency of the compressor to the first set frequency for temperature adjustment;
S01, acquiring the current temperature of the centrifugal chamber;
S41, in a case where the difference between the current temperature and the set temperature is greater than the difference threshold value, according to the difference between the current temperature and the set temperature, adjusting the operating frequency of the compressor to the second set frequency for temperature adjustment;
S02, in a case where the difference between the current temperature and the set temperature is less than or equal to the difference threshold value, according to the set temperature and the set rotational speed of the rotor, determining the target input parameter for temperature adjustment; and
S03, inputting the target input parameter, the current temperature and the set temperature into the PID controller for temperature adjustment.

With the method for temperature control of the centrifuge provided by the embodiment of the present disclosure, the centrifuge can acquire the current temperature of the centrifugal chamber, and in a case where the difference between the current temperature and the set temperature is less than or equal to the difference threshold value, such as the difference between the current temperature and the set temperature is too small, the centrifuge employs the PID controller to accurately control the temperature adjustment on the centrifugal chamber. During the actual cooling process, due to the heat generated by the friction between the rotor and the air, the centrifuge with PID cooling control algorithm is easily affected by the heat generated by the friction between the high-speed rotating rotor and the air, which interferes with the normal PID control, resulting in a great difference between the actual temperature curve and the ideal temperature control curve. Therefore, the centrifuge determines the target input parameter according to the set temperature and the set rotational speed of the rotor, and the centrifuge inputs the target input parameter, the current temperature and the set temperature into the PID controller for temperature adjustment. The embodiment incorporates the rotational speed of the rotor into the control algorithm, inputs the target input parameter into the PID controller for temperature adjustment, avoids the influence of heat generated by friction between the high-speed rotating rotor and the air during the centrifugal cooling process, and improves the accuracy of temperature adjustment of the centrifuge. Further, before acquiring the current temperature of the centrifugal chamber, according to the difference between the initial temperature and the set temperature, the centrifuge adjusts the operating frequency of the compressor to the first set frequency for temperature adjustment. After acquiring the current temperature of the centrifugal chamber, in a case where the difference between the current temperature and the set temperature is greater than the difference threshold value, according to the difference between the current temperature and the set temperature, the centrifuge adjusts the operating frequency of the compressor to the second set frequency for temperature adjustment. It can make the temperature of the centrifugal chamber rapidly approaching the set temperature, and then accurately adjust the temperature by PID controller, which improves the efficiency of temperature adjustment of centrifuge.

With reference to FIG. 6, the embodiment of the present disclosure provides a device for temperature control of the centrifuge comprising a processor 100 and a memory 101. Optionally, the device may also comprise a communication interface 102 and a bus 103. The processor 100, the communication interface 102, and the memory 101 can communicate with each other through the bus 103. The communication interface 102 may be used for information transmission. The processor 100 may invoke logic instructions in the memory 101 to execute the method for temperature control of the centrifuge of the above embodiments.

Further, the logic instructions in the memory 101 described above may be realized in the form of software functional units and may be stored in a computer readable storage medium when sold or used as an independent product.

As a computer readable storage medium, the memory 101 may be used to store software programs, computer executable programs, such as program instructions/modules corresponding to the methods in embodiments of the present disclosure. The processor 100 executes functional applications as well as data processing by running program instructions/modules stored in the memory 101 i.e. implementing the method for temperature control of the centrifuge in the above-mentioned embodiments.

The memory 101 may comprise a stored program area and a stored data area, the stored program area may store an operating system and an application program required for at least one function. The storage data area may store data created according to the use of the terminal device. In addition the memory 101 may comprise a high-speed random access memory and may also comprise a non-volatile memory.

The embodiment of the present disclosure provides a centrifuge, which comprises the above-mentioned device for temperature control of the centrifuge.

The embodiments of the present disclosure provide a storage medium storing computer-executable instructions configured to execute the method for temperature control of the centrifuge.

The storage medium may be a transient storage medium or a non-transient storage medium.

The technical solution of the disclosed embodiments may be embodied in the form of a software product stored in a storage medium, comprising one or more instructions for causing a computer device (which may be a personal computer, server, or network device, etc.) to perform all or part of the steps of the method of the disclosed embodiments. The aforementioned storage medium may be a non-transient storage medium comprising a USB disk, a mobile hard disk, a read-only memory (ROM), a random access memory (RAM), a magnetic disk or an optical disk, and other media capable of storing program codes, or may be a transient storage medium.

The above description and drawings sufficiently illustrate embodiments of the present disclosure to enable those skilled in the art to practice them. Other embodiments may comprise structural logical electrical procedural and other changes. The embodiments represent only possible variations. Unless explicitly required, individual parts and functions are optional, and the order of operation can vary. Portions and features of some embodiments may be comprised or in place of portions and features of other embodiments. Furthermore, the terms used in the present disclosure are used only to describe embodiments and are not used to limit the claims. As used in the embodiments and in the description of the claims, the singular forms of “a”, “an” and “the” are intended to comprise the plural forms as well, unless the context clearly indicates. Similarly, the term “and/or” as used in this application means encompassing one or more associated lists of any and all possible combinations. Additionally, when used in this application, the term “comprise” and its variants “comprises” and/or comprising, etc. refer to the presence of stated features, totals, steps, operations, elements, and/or components, but do not exclude the presence or addition of one or more other features, totals, steps, operations, elements, components, and/or groupings of these. In the absence of further limitations, an element defined by the phrase “comprises a/an . . . ” does not preclude the existence of another identical element in the process, method or device in which the element is included. Herein each embodiment may be highlighted as being different from the other embodiments and the same similar parts between the various embodiments may be referred to with respect to each other. For the method, product, etc. disclosed by the embodiment, if it corresponds to the method portion disclosed by the embodiment, reference can be made to the description of the method portion where relevant.

Those skilled in the art will appreciate that the various example units and algorithm steps described in connection with the embodiments disclosed herein can be implemented in electronic hardware or a combination of computer software and electronic hardware. Whether these functions are performed in hardware or software can depend on the specific application and design constraints of the technical solution. One skilled in the art may use different methods for each particular application to implement the described functionality but such implementation should not be considered outside the scope of the disclosed embodiments. It will be apparent to one skilled in the art that for convenience and conciseness of description, the specific operating processes of the above-mentioned systems, devices and units may be referred to the corresponding processes in the aforementioned method embodiments and will not be repeated herein.

In the embodiments disclosed herein, the disclosed methods, and products (including but not limited to devices, devices, etc.) may be implemented in other ways. For example, the above-mentioned embodiment of the device is only schematic, for example, the division of the unit may be only a logical function division, and in practice there may be another division mode, for example, multiple units or components may be combined or integrated into another system, or some features may be ignored or not performed. In addition, the coupling or direct coupling or communication connection between each other shown or discussed may be indirect coupling or communication connection through some interface, device or unit, and may be electrical, mechanical or other form. The elements illustrated as separate elements may or may not be physically separated, and the elements displayed as elements may or may not be physical elements, i.e. may be located in one place, or may be distributed over a plurality of network elements. Some or all of the units can be selected according to actual needs to realize the embodiment. In addition, each functional unit in the embodiment of the present disclosure may be integrated in one processing unit, each unit may exist physically independently, or two or more units may be integrated in one unit.

The flowcharts and block diagrams in the accompanying drawings illustrate the architecture functionality and operation of possible implementations of systems methods and computer program products according to embodiments of the present disclosure. In this regard, each block in a flow chart or block diagram may represent a module, program segment, or part of code containing one or more executable instructions for performing a specified logical function. In some alternative implementations, the functions indicated in the block may also occur in a different order than those indicated in the drawings. For example, two successive blocks can actually be executed substantially in parallel, or they can sometimes be executed in reverse order, depending on the functionality involved. In the description corresponding to the flowcharts and block diagrams in the drawings, the operations or steps corresponding to different blocks may also occur in a different order than that disclosed in the description, and sometimes there is no specific order between the different operations or steps. For example, two successive operations or steps can actually be performed substantially in parallel, or they can sometimes be performed in reverse order, depending on the functionality involved. Each block in the block diagram and/or flow chart, and a combination of the blocks in the block diagram and/or flow chart, may be implemented in a dedicated hardware-based system that performs a specified function or action, or may be implemented in a combination of dedicated hardware and computer instructions.

1. A method for temperature control of a centrifuge comprising a housing, a centrifugal chamber disposed in the housing, a rotor disposed in the centrifugal chamber, a refrigeration device for adjusting the temperature of the centrifugal chamber and a PID controller controlling the refrigeration device to adjust the temperature of the centrifugal chamber, comprising:
acquiring a current temperature of the centrifugal chamber;
in a case where a difference between the current temperature and a set temperature is less than or equal to a difference threshold value, according to the set temperature and a set rotational speed of the rotor, determining a target input parameter; and
inputting the target input parameter, the current temperature and the set temperature into the PID controller.

2. The method according to claim 1, wherein the step of, according to the set temperature and the set rotational speed of the rotor determining the target input parameter comprises:
determining a temperature range in which the set temperature is located;
according to a corresponding relationship, determining a PID parameter corresponding to the temperature range; and
according to the PID parameter and the set rotational speed, determining the target input parameter;
wherein the PID parameter comprises a proportional parameter, an integral parameter and a differential parameter.

3. The method according to claim 2, wherein the step of, according to the PID parameter and the set rotational speed, determining the target input parameter comprises:
according to the set rotational speed, determining a correction coefficient; and
according to the correction coefficient, the proportional parameter, and the integral parameter, determining the target input parameter.

4. The method according to claim 3, wherein the step of, according to the set rotational speed, determining the correction coefficient comprises:
calculating K=(S/Smax)²;
wherein K is the correction coefficient, Smax is the maximum rotational speed of the rotor, and S is the set rotational speed.

5. The method according to claim 3, wherein the step of, according to the correction coefficient, the proportional parameter, and the integral parameter, determining the target input parameter comprises:
calculating P=K×P0, I=K×I0;
wherein, the target input parameter comprises a proportional input parameter and an integral input parameter, P is the proportional input parameter, I is the integral input parameter, and K is the correction coefficient; P0 is the proportional parameter, and I0 is the integral parameter.

6. The method according to claim 1, before acquiring the current temperature of the centrifugal chamber, further comprising:
according to a difference between an initial temperature and the set temperature, adjusting an operating frequency of the compressor to a first set frequency.

7. The method according to claim 1, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.

8. A device for temperature control of a centrifuge, comprising a processor and a memory having program instructions stored therein, wherein the processor is configured to execute the method for temperature control of the centrifuge according to claim 1 when executing the program instructions.

9. (canceled)

10. A non-transitory storage medium having program instructions stored therein, when the program instructions are run, the method for temperature control of a centrifuge according to claim 1 is executed.

11. The method according to claim 4, wherein the step of, according to the correction coefficient, the proportional parameter, and the integral parameter, determining the target input parameter comprises:
calculating P=K×P0, I=K×I0;
wherein, the target input parameter comprises a proportional input parameter and an integral input parameter, P is the proportional input parameter, I is the integral input parameter, and K is the correction coefficient; P0 is the proportional parameter, and I0 is the integral parameter.

12. The method according to claim 2, before acquiring the current temperature of the centrifugal chamber, further comprising:
according to a difference between an initial temperature and the set temperature, adjusting an operating frequency of the compressor to a first set frequency.

13. The method according to claim 3, before acquiring the current temperature of the centrifugal chamber, further comprising:
according to a difference between an initial temperature and the set temperature, adjusting an operating frequency of the compressor to a first set frequency.

14. The method according to claim 4, before acquiring the current temperature of the centrifugal chamber, further comprising:
according to a difference between an initial temperature and the set temperature, adjusting an operating frequency of the compressor to a first set frequency.

15. The method according to claim 5, before acquiring the current temperature of the centrifugal chamber, further comprising:
according to a difference between an initial temperature and the set temperature, adjusting an operating frequency of the compressor to a first set frequency.

16. The method according to claim 11, before acquiring the current temperature of the centrifugal chamber, further comprising:
according to a difference between an initial temperature and the set temperature, adjusting an operating frequency of the compressor to a first set frequency.

17. The method according to claim 2, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.

18. The method according to claim 3, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.

19. The method according to claim 4, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.

20. The method according to claim 5, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.

21. The method according to claim 6, after acquiring the current temperature of the centrifugal chamber, further comprising:
in a case where the difference between the current temperature and the set temperature is greater than the difference threshold value, according to the difference between the current temperature and the set temperature, adjusting an operating frequency of the compressor to a second set frequency.
